(19) United States
(12) Patent Application Publication
(10) Pub. No.: US 2012/0330744 A1
(43) Pub. Date: Dec. 27, 2012

(54) Real-Time Multi-Merchant Multi-Payer Multi-Bucket Open Loop Debit Card, Credit Card or Mobile Payment Device Value Tracking and Discount Processing Systems and Related Methods

(76) Inventor: Nebil Ben Aissa, Chicago, IL (US)

(21) Appl. No.: 13/532,449

(22) Filed: Jun. 25, 2012

Related U.S. Application Data
(60) Provisional application No. 61/501,062, filed on Jun. 24, 2011.

(51) Int. Cl. G06Q 30/02; G06Q 20/20

(52) U.S. Cl. 705/14.38

(57) ABSTRACT

A system for receiving a real-time discount with an open loop debit card, credit card or mobile payment device in a multi-merchant, multi-payer commercial environment. The system has a plurality of buckets with information concerning discounts currently available, a point of sale (POS) device initiates a transaction, a financial processor transmits a query to an account issuing bank to determine whether the payer has sufficient funds for the transaction, the issuing bank communicates with the discount system in real time to determine if a discount is available, if a discount is available, the issuing bank borrows the amount of the discount by from an issuing bank discount reserve pooled (IBDRP) account and the issuing bank credits the payer's account in real time with the amount of the discount.

### CROSS-REFERENCE TO RELATED APPLICATION

This patent application claims the benefit of U.S. provisional patent application Ser. No. 61/501,062, filed Jun. 24, 2011.

### FIELD OF THE INVENTION

The present invention relates generally to methods and systems which enable buyers get real-time discounts on their purchases across many merchants using an open loop regular universally accepted debit card, credit card or mobile payment device without using coupons, discount certificates, gift certificates, loyalty cards, discount codes or gift cards.

### BACKGROUND OF THE INVENTION

An appreciation of the following definitions, concepts and typical debit card, credit card and mobile payment processing operations will assist in understanding the present invention.

Online and web-based merchants and retailers offer various discounting schemes to attract new buyers and to grow sales. It may be helpful to review a few discounting methods and understand how these different types of discounts work.

Coupons: A coupon is usually a piece of paper with a specific offer, for example the coupon could say: “save 75 cents on a specific box of cereal brand”. Coupons are usually free, can be used only once, expire on a specific date, apply to a limited quantity and might have special disclaimers, such as “limit to 2 boxes of cereal; or not valid in Alaska!”.

Coupons are usually made out of paper, are presented by the buyer to the clerk at a store (or entered on a web portal). The clerk scans the coupon or manually enters it on a Point of Sale (POS) system, such as a more basic POS 100 shown in FIG. 1A or a more feature-rich POS 150 shown in FIG. 1B. The coupon could also be electronic, where it is emailed to the buyer's smart phone or email account. The buyer either enters the electronic coupon on the merchant's web portal, prints it and brings it with at transaction time, or displays the coupon from his/her smart phone to the merchant's clerk who scans it or manually enters it into the POS. The merchant's store POS system, or shopping cart software (in case of an online transaction), recognizes the coupon identification number and automatically applies the discount to the purchased item or transaction. The buyer then pays the discounted amount of the transaction with cash, a credit card or mobile phone. The transaction is then complete

Discount Code: A discount code is technically a digital coupon, and it is usually offered and used in an electronic format. An online shopper is presented with a discount code, either via email or from a web portal. The shopper browses the merchant's web store, adds items onto a web shopping cart, then when the shopper is ready to check out, he/she enters the discount code in a specific section in the shopping cart web portal interface, and the total amount of the purchase is discounted by a percentage (% off) or by a fixed amount, such as $5.00 off. Then, the shopper proceeds to the check-out section of the shopping cart, and pays for the final discounted transaction net amount using a debit card, credit card, online bank account or mobile phone.

Discount Certificate: A discount certificate is very similar to a coupon, but is usually purchased for a fee and can be used only once. For example, let's assume that a spa markets a new offer: “It's Mother's Day, buy your mother $100.00 worth of spa services for $50.00!”. It may be helpful to go through a sample scenario and understand the full transaction process involving a discount certificate:
1. The merchant markets a discount certificate for sale: “Buy your mother $100.00 worth of spa services for $50.00”.
2. Son goes to the merchant's physical location or online web site, pays the merchant $50: at the store or online. He receives a printed gift certificate clearly stating that the bearer can purchase $100 worth of goods or services at the spa.
3. Son gives the printed discount certificate to mom on Mother's Day.
4. Mother takes the printed certificate with her and goes to the Spa.
5. Mother gets a $125 worth of goods and services at the spa.
6. At checkout, mother gets a $125 invoice for the goods and services which she has enjoyed at the spa.
7. Mother presents the $100 discount certificate to the clerk standing by the Point of Sale (POS) device.
8. The checkout clerk reads the offer on the discount certificate, authenticates it by entering the certificate's number into an authentication system, then applies the discount onto the POS system. The total invoice of $125 is discounted by $100, thus reduced to a net payment of $25 out of pocket to Mother.
9. The checkout clerk asks mother to pay $25.
10. The checkout clerk asks mother for a method of payment: cash, charge or mobile payment?
11. Mother pays for the fully discounted transaction either via cash, charge card or mobile payment.
12. The transaction is then complete.

Gift Certificate: A gift certificate is very similar to a discount certificate. However, it is usually bought at face value with no discounts, and like a discount certificate it can typically be used only once. Let's use the earlier example of mom receiving a spa certificate to explain the usage of gift certificates. Here are the steps involved in a gift certificate transaction:
1. Merchant markets gift certificates for sale: “Buy your mother $100 worth of Spa services for $100”.
2. Son buys a $100 gift certificate either at the merchant's physical location or online. He pays $100 for $100 worth of Spa spending. He receives a printed gift certificate clearly stating that the bearer can purchase $100 worth of goods and services at the spa
3. Son gives the printed gift certificate to mom on Mother's Day.
4. Mother goes to the Spa . . . the remaining steps are pretty much the same as described above in the discount certificate process.
5. End of transaction

Gift card: A gift card is somewhat similar to a gift certificate. It is usually bought for a fee. However it can be used multiple times over multiple transactions until the full amount (value) stored on the card is depleted or the value on the card expires. Let's use the earlier example of mom receiving a spa certificate to explain the usage of gift card. Here are the steps involved in a gift certificate transaction:
1. Merchant markets gift cards for sale: “Buy your mother $1,000 worth of spa services for $1,000”.
2. Son buys a $1,000 gift card either at the merchant's physical location or online. He pays $1,000 for $1,000 worth of spending. He receives a gift card clearly stating that the bearer can purchase $1,000 worth of goods and services at the spa.
3. Son gives the gift card to mom on Mother's Day.
4. Mother goes to the Spa. She spends only $30 worth of spa services. She now has $970 of value left ($1,000−$30=$970).
5. She goes back again to the spa, spends $50 worth of spa services. She now has $920 of value left ($970−$50=$920).
6. In case mother never goes back to spend the remaining $920 stored in her gift card, then the card will expire and the value is automatically escheated back to Mother, the merchant or to the local state government.
7. End of card value.

Loyalty Card: A common example of a loyalty card is the grocery card which many carry on their key chains or in their wallet. The objective of the loyalty card is to track a shopper's transaction history and buying habits and offer them loyalty based discounts to encourage them to buy more. Such loyalty offers could be: “If you buy $100 worth of groceries this week, then you get $20 off your purchase next week”, or another example: “if you buy $100 worth of groceries today, then you get 20% off your next purchase, where the 20% discount can not exceed $20”. Many merchants prefer to give their clients loyalty cards, because, not only they encourage clients to buy more, but they also give merchants insights into their clients buying patterns and habits.

In a payment transaction there are two parties: a Payer of funds also referred to as: a shopper; and an acquirer of funds also referred to as: a merchant.

In order for a payment transaction to conclude, funds are transferred from the payer's (buyer) bank account to the acquirer's (merchant) bank account via a payment network. As a result, a payment processing network is technically all systems involved in authenticating, validating and enabling in real time the flow of funds from a payer to an acquirer.

A Payment processing network is an aggregation of payment collection devices such as Point of Sale (POS) devices, computer server systems, banking transaction processing systems, and database server systems which enable the transfer of money from a payer's bank account (buyer), to an acquirer's bank account (merchant). A basic POS 100 for receiving a credit or debit card 102 is shown in FIG. 1A. A more sophisticated POS 150 is illustrated in FIG. 1B. POS 150 may be equipped with a larger display, a bar code scanner and a cash drawer. Payment may also be made via a mobile device 200 shown in FIG. 2. For example, a mobile device 202 may pay via a quick response (QR) code, a mobile device 204 may pay via near field communication (NFC) technology, or a keychain 206 with an internal radio frequency identification (RFID) chip may pay when placed in proximity to the POS.

Payment method: a payer could chose to pay for their transaction via various payment methods: cash, check, debit card, credit card or mobile phone. If the payment is not made in cash, then the payer must have a bank account linked to their check, debit card, credit card or mobile phone payment.

In order for a payer to be able to conclude a successful payment transaction using their debit card, credit card or mobile payment method; the payer must have a linked bank account to their payment method, and their bank account must have enough funds to cover for the payment transaction.

The payer presents their payment method: debit card, credit card or mobile device to the acquirer's physical location (such as a retail store) or virtual location (such as a web site) and the acquirer accepts funds from the payer using a payment acquiring system linked to the payment network, which transfers funds from the payer's bank account to the acquirer's bank account.

If the payer intends to pay with their debit, credit or mobile phone at a physical location, then the acquirer would most likely use a Point of Sale (POS) payment acquiring device compatible with the payer's payment method; In other words:
a. If the payer (shopper) intends to pay with a debit card and intends to enter their debit card PIN (Personal Identification Number) for transaction authentication, then the acquirer (merchant) should have a POS device which supports PIN debit card transactions.
b. If the payer (shopper) intends to pay with a credit card and intends to sign a printed paper receipt, then the acquirer (merchant) should have a POS device which prints a receipt onto which the payer could sign for the transaction, or offer them a POS device with an electronic signature pad.
c. If the payer (shopper) intends to pay with their mobile phone, then the acquirer (merchant) should have a POS device which supports mobile phone payments.

In the case the payer intends to pay at a virtual location such as a web site, then acquirer would us an electronic commerce shopping cart linked a payment gateway to the payment network. After funds are acquired from the payer's bank account, using the payment network, they are settled onto the acquiring merchant's bank account.

When acquiring funds from a payer at a physical location, the acquiring merchant requires that the payer swipes their debit card or credit card onto a Point of Sale magnetic card reader device. Or by requiring the payer to wave their mobile phone by a Point of Sale device which could identify the payer's phone number through Near Field Communication (NFC) wireless technology, a Radio Frequency (RF) tag embedded onto the phone or the phone's SIM card, two dimensional bar code technology such as Quick Response (QR) Code technology, or some other wireless technology which enables the merchant to link the mobile phone to the payer's identity.

Once funds are acquired from the payer to the merchant, using the payment network, funds are then deposited onto the merchant's acquiring bank account.

While debit cards and credit cards are similar in some respects, there are significant differences. A main difference is that debit cards do not carry a line of credit. With a debit card, once the cash balance reaches zero, the debit card can no longer be used for further transactions. A cash balance for a debit card cannot go negative. On the other hand, a credit card can transact in the negative. Although, credit cards have credit limits, the credit cards will frequently transact further once a payer reaches his/her maximum allowed credit line.

Debit cards are usually issued with zero funds and payers have to load a related account in order to be able to use them. A debit card could be loaded with cash, a wire transfer, a check, an electronic (ACH: Automated Clearing House) bank deposit, or a load transaction from another debit card, credit card or mobile payment device. Once funds are loaded and available, debit payers can use the card to make purchases at various POS devices or online.

Credit cards, on the other hand, are issued with a line of credit and payers could use the card immediately upon receiving it to make purchases. Credit payers then have to pay down the borrowed credit plus interest on a monthly basis to the issuing bank in order to continue using the card.

Both debit and credit cards display a network logo on the card, such as Visa™, MasterCard™, American Express™ or the like. The cards are issued by an issuing bank, transact on POS systems and settle funds into merchant accounts. As mentioned above, the main difference is that a debit card will not transact if there insufficient funds in the related bank account.

Mobile payment devices such as portable telephone handset, a keychain payment device, a portable tablet device, a smart phone device, or an electronic type of device with ability to make real-time communication with a central server are usually linked to a bank account, a debit card or credit card and are used to pay for purchases at physical retail locations or virtual web sites.

In some cases the mobile payment device is embedded with a transceiver in order to initiate a payment transaction. Technologies such as Near Field Communication (NFC) transceivers or Radio Frequency (RF) transceivers are placed on the mobile payment device in order for the merchant's Point of Sale (POS) to recognize the device's unique identification and link it to the payer's account. By using a hardware POS solution to identify the payer's account, the POS system communicates the unique identification of the mobile device to the payment network and initiates the process of moving funds from the payer's bank account to the merchant's bank account.

In some cases the mobile payment device is not embedded with a transceiver in order to conduct the payment transaction. In fact the mobile device would embed a software application, also referred to as an “App”, to facilitate payment. The software application would run on a smart phone with a mobile operating system and would display unique payment codes presented in readable letter and digit combinations, single dimensional barcode, or two dimensional barcode technology also referred as Q-Codes. Using these codes which are displayed on the phone, the merchant would have the corresponding technology to read the unique code displayed by the device's software app, read it, then securely send the information to a server in order to initiate the payment process of moving funds from the card holder's bank account to the merchant's bank account.

The differences between an open loop payment processing network and a closed loop payment processing network, are as follows:

A closed loop payment network is usually a processing system owned by a single retailer. For example, compare a Sears™ charge card to a Visa™ charge card. The Sears charge card allows the consumer to buy goods and services only at Sears' stores. It cannot be used at a restaurant, a bar, or a competing retailer. On the other hand, a Visa card allows the consumer to buy goods and services at millions of merchants as long as the card has sufficient funds or available credit.

Another good example of a closed loop payment network which encompasses payments with debit cards, credit cards or mobile phone payment methods is the Starbucks™ closed loop payment and loyalty system; where a client could walk to a Starbucks™ coffee shop and pay with their Starbucks™ Rewards card or mobile phone which are linked to a bank account, a credit card or debit card. Upon paying with the Starbucks™ Rewards card or mobile phone, the Starbucks™ systems automatically withdraw funds from the buyer's linked bank account to either reload the card or mobile account, or wait until the account is depleted then refill it at a later date.

An open loop universally accepted credit card, debit card or mobile payment processing network is technically an internationally identified financial card or mobile payment service, typically under trademarks such as PayPal™ Visa™, MasterCard™, American Express™, Discover™, Diners Club™, JCB™ (accepted in Japan), Union Pay™ (accepted in China) and the like. These are international (universal) networks which enable hundreds of millions of payers or mobile phone subscribers to purchase goods and services at millions of merchant locations. Furthermore, funding rules, returns, fraud coverage and consumer protection governance are stringent and rarely changed. While interest and surcharge rates can be changed frequently, how a merchant authorizes and settles (deposits) funds at their bank is very well defined and rarely modified.

Closed loop payment networks are typically much easier to build, manage and modify. This is primarily because closed loop networks are owned by a single entity and are developed and customized by the entity's Information Technology (IT) department which has full control to change credit payment, settlement and loyalty rules. The merchant and its IT department are both judge and jury on any rules relating to its privately issued charge card or mobile payment devices. On the other hand, one cannot change or modify payment or settlement rules of an open loop network card because such rules need to be modified across thousands of banks, millions of merchants and hundreds of millions of payers.

In addition to the fundamental differences between open and closed loop payment network: where one is proprietary and self-governing, while the other is universal and publicly acknowledged. Closed loop payment networks are limited as they accept debit, credit or mobile payments at a single merchant brand compared to being accepted by millions of merchant brands across hundreds of countries, cultures and languages.

Consideration will however be given to how open loop payment networks work in order to demonstrate the unique value proposition of the present invention which uses the open loop credit card, debit card and mobile payment network model. A sample purchase transaction will assist in understanding how money flows from the payer to the merchant. For example, let's assume that a shopper goes to a spa and decides to pay with a debit card, credit card or mobile phone instead of cash. Let's analyze the process, consider the various financial entities involved and understand international electronic payment industry rules and regulations.

With reference to FIGS. 3 and 4, a customer presents the clerk with a payment card or mobile device 102 (step 402). The clerk checks the card or mobile (step 404) and confirms that the logo on the front of the card (the issuing network) or mobile phone is supported by the POS device used by the merchant (step 406).

In order for the payment to go through, the POS device must support the card's issuing network or mobile payment issuing network. The issuing network is easily identifiable by the logo on the front of the card or mobile device. It could be Visa™, MasterCard™, American Express™, Paypal™, Discover™ or the like. For this reason, some merchant locations will place a sticker on their entrance doors stating, for example, that they accept Visa™, Paypal™ MasterCard™ but not America Express™, or other combinations of acceptable/unacceptable networks.

The issuing bank can be identified by looking at the back of the credit card, debit card or mobile device. The back of the card or device typically includes some fine print, at least one toll free support telephone number and the name of a banking institution. The identified banking institution is where the payer's money is stored and debited when the client makes purchase transactions. In the case of a mobile software application, the issuing bank is the financial institution that stores the funds that are linked to the mobile device.

In a typical purchase transaction, the clerk enters the transaction amount on the POS device 100 and then either swipes the card 102 on the POS device (step 412) or allows the payer to wave their mobile payment device in front of POS device which accepts mobile payments.

The POS device contacts the financial processing system 302 (step 418), the financial processor, which contacts the issuing bank 308 to check if the payer has enough funds or enough remaining credit for the transaction (step 420 and 422).

The financial processor's main objective is to move funds from the payer's bank account at the issuing bank 308 to the merchant's bank account at the merchant's bank 306.

The merchant's bank account is the account associated with the merchant to which credit card, debit card or mobile payment device transactions are deposited. The merchant's bank account resides within a financial institution called the Merchant Bank.

The Merchant Bank holds the merchant account's funds and it takes a percentage of the transaction called: the interchange, which is then shared between the merchant bank, the processor, the issuing bank and the financial network.

Upon swiping a card or waving a mobile phone on a POS device, an additional amount might be added to the transaction. These additions could be industry specific tips or security deposits (step 414). These transaction additions could be applied as percentages or fixed amounts. The amount added to the transaction is a preliminary estimation by the POS device and typically depends on the merchant's industry card processing practices. For example, if the transaction is initiated from a restaurant, then the POS might automatically add a 20 percent tip to the transaction amount. On the other hand, if the transaction is initiated from a car rental merchant, an automatic $250 (fixed) security deposit may be added to the rental amount. This deposit may be later released if the car is returned undamaged.

After calculating the transaction's Preliminary Gross Amount=actual transaction amount+tips and/or security deposits initially added by the system (step 416), then the POS device contacts the financial processor which contacts the issuing bank to confirm that the payer's account has enough funds to cover the gross transaction (steps 420 and 422).

If the debit card, credit card or mobile device's payment network (such as Visa™, MasterCard™, or American Express™) is not supported on by the acquiring POS device processing system (Processor), then the POS displays a “Declined” or “Not supported” message (step 426), and the client is advised to use a different type of payment method which is supported by the POS device.

If the payer's account, held at the issuing bank, does not have enough funds, then the transaction is declined. The POS displays a “Declined” message, and the client is advised to use a different type of payment.

If the payer's account has enough funds, then the financial processor 302 sends electronic information to the issuing bank 308 and simultaneously executes two transactions: (1) Authorization 310, then (2) Settlement 312.

Authorization in payment processing terminology means that the funds are reserved aside or frozen until further notice.

Settlement in payment processing terminology means that the funds are actually moved from the payer's account to the Merchant's account.

If the funds are authorized, that is, the funds are frozen and set aside, then there are only two options to un-freeze them and lift the authorization transaction (step 430).

Authorization time expires (step 440). For example, an authorization time period could be a three day period for a $250 car rental deposit. After three days from the end of a car rental transaction, and if everything is OK with the rented car, then the $250 deposit which was reserved aside is released back the payer.

A Settlement Transaction is issued canceling the authorization transaction (step 440). Unlike the authorization transaction which freezes funds until an expiration time, a settlement transaction is an actual fund transfer from the payer's issuing bank account to the merchant's commercial bank account.

The financial processor sends a message to the POS device confirming that the preliminary gross amount has been authorized (set aside) (step 432). The POS device displays an “Approved” message (step 434). The POS device might print a receipt at the merchant location describing the transaction total (step 436), and allowing the payer to add a tip to the original transaction amount.

The clerk presents the receipt to the payer (step 438). The clerk might also ask the payer to enter a tip on top of the total amount. The payer enters the tip (step 444), totals the full amount (total amount+tip), signs the receipt and gives it back to the clerk. The payer keeps a copy of the full transaction and gives a copy to the clerk (step 446). The payer then walks away. At this point the payer is no longer involved in the transaction.

The Clerk enters the Actual Gross Amount of the transaction onto the POS device; where the actual gross amount is the amount which the payer has agreed to pay. Note that the actual gross amount is frequently different from the preliminary gross amount. For example, when paying for a restaurant transaction, the preliminary gross amount could be the dinner's total plus a tip estimation of 20%. On the other hand, the actual gross amount, which the payer has agreed to pay, could be the dinner's total plus 30% in case the payer had a great experience, or could be the total plus 5% in case the payer had a below than average service.

The POS device communicates the actual gross amount to the financial processor. The actual gross amount is often different that the pre-authorized gross amount.

The processor executes a Settlement transaction equal to the actual gross amount (steps 450 and 452), and lifts all authorizations pertaining to this transaction except security deposits which are automatically lifted when the expiration time occurs. For example: if the payer had dinner for $100.00; and the POS authorized a preliminary amount of $120=$100+20%; and the payer signed for $118.00; then the financial processor executes a settlement transaction (a fund transfer) of $118.00 from the payer's issuing bank account to the merchant's account. As a result, the $118.00 settlement is technically a $2.00 credit adjustment to the earlier pre-authorized gross of $120.

The financial processor 302 sends a message to the POS device 100 confirming that the funds have been moved from the payer's issuing bank 308 account to the merchant's bank 306 account (step 454). The payment transaction is then complete (step 456).

It is believed that the above steps capture the main concepts which take place when a payer uses his or her card or mobile device 102 to make purchases. Note that the above description was for an open loop payment network taking place at a physical “brick and mortar” merchant location, and that these steps can be repeated when describing the steps involved when transacting on an open loop payment network during a web based online transaction. In fact, both transactions, online or physical brick and mortar, go through the exact same steps when utilized in connection with the present invention.

A general object of the present invention is to provide real-time multi-merchant discounting systems and methods which eliminate the hassle, embarrassment, forgetfulness and overhead experienced by consumers presenting coupons, gift certificates, discount codes, club loyalty cards, and/or gift cards in order to get discounts on their purchases.

Another object of the present invention is to provide buyers with automatic real time discounts on their purchases, across many merchants, using a universally accepted open loop debit card, credit card or mobile payment device without presenting a coupon to a merchant clerk or making any adjustments to the transaction on the Point of Sale (POS) device or at a web based electronic commerce online store.

### SUMMARY OF THE INVENTION

The present invention allows a payer to transact, on an open loop payment network, at a discount. This means that a person could walk into a restaurant, is invoiced $100 for the food which he consumed, he pays and signs for $100 to be withdrawn from his bank account, the clerk at the POS transacts $100 to be transferred from the payer to the merchant; BUT only $70 would be settled from the payer account into the merchant's account. This means that the actual gross amount of funds transferred from the payer to the merchant need to be discounted, and the funds expected to be settled by the merchant's bank will be less than the funds settled by the issuing bank. This might be easy to accomplish if the POS system, issuing bank, merchant bank, financial processor and network are part of a controlled closed loop system. However, such transaction is impossible to accomplish with an independent POS system in an open loop credit, debit or mobile payment network where the issuing bank and a merchant bank which are unrelated.

Per earlier sections, payment systems will allow a settlement to be less than an authorization. However, once the settlement amount is issued by the POS system, then the settlement amount that is expected to be transferred from the issuing bank shall be exactly equal to the settlement amount expected by the merchant bank. Furthermore, payment networks must enforce that the actual settlement amount owed by the payer to the merchant (including taxes, tips . . . etc.) should be paid exactly as expected, and funds must be transferred in full from the payer's issuing bank to the merchant's bank. In addition, any modifications to the transaction will be rejected by transaction checks and balances coming from the POS system, the issuing bank, the merchant bank, the financial processing system and the open loop payment network.

The present invention is directed to systems and methods which enable buyers get real-time discounts on their purchases across many merchants using an open loop regular universally accepted debit card, credit card or mobile payment device without using coupons, discount certificates, gift certificates, loyalty cards, discount codes or gift cards. Buyers purchase goods and services at many merchants and receive instant discounts using a regular universally accepted debit card, credit card or mobile payment device; while multi-merchant authorized discounts are electronically transacted in real-time without being funded by the buyer. Real-time discounts are processed across multiple consumers and multiple merchants via paperless, automated, hassle free real-time purchase discounting methods over regular and universal open loop payment networks, regular Point of Sale (POS) devices or regular web portal shopping carts.

The present invention is further directed to methods which provide sophisticated and complex discounting methods to unsophisticated merchants with off the shelf non-customized POS devices or electronic shopping cart systems. The solution does not require any special training for buyers; nor does it require the use of a specialized or proprietary (closed loop) payment network technology. Furthermore, merchants require no special installation of hardware, no software implementation, no customization, and no additional clerk training in order to properly discount the transaction at a Point of Sale (POS) device or at a web shopping cart.

Although the transaction eventually settles at a discount, both buyer and merchant experience a seamless non-discounted purchase at the POS or web shipping cart. In fact, the discounted transaction would look exactly the same as a non-discounted transaction, and anyone watching the transaction taking place at the front-end Point of Sale (POS) device or at the online shopping cart would observe no special processes or transaction irregularities. Achieving such seamless process might be accomplished in a closed loop network where the merchant has built a customized transacting network and has control over the POS software, infrastructure, banking settlement rules and related technologies. However, given that the present invention uses open loop payment networks, off-the shelf non-custom POS devices or shopping carts, and because of the highly regulated banking rules which are enforced by international and federal authorities, the ability to discount a transaction in real time without changing the federal and international bank rules requires complex back office processing systems and methods.

This invention gives the merchant the ability to offer real-time discounted transactions, fully automated in the back office, without the need to markdown the transaction at the merchant's Point of Sale. This gives the merchant (1) full control of their discount campaigns across many of their retail locations, at either a physical location or a web portal, and (2) helps them avoid substantial losses. Such losses could be caused by buyers printing fake coupons or rebates and receiving unauthorized cash discounts; or simply caused by clerk theft via collusion with clients where clerks offer friends legitimate but unauthorized discounts then collect a portion of the discounted transaction in a form of a kickback.

In accordance with another aspect of the present invention, the present systems and methods provide complex real-time discounting across an unlimited number of merchants, which is very difficult and tedious to accomplish. A “multi-bucket” real-time discount processing system enables a buyer to use a universally accepted debit card, credit card or mobile payment device yet have various discount offers with various expiration dates per merchant location. Assume tens of millions of users, hundreds of thousands of merchants, hundreds of locations per merchant, and tens of discount offers per buyer per merchant location; and one could end up with a system that needs to track trillions of complex rebate permutations per transaction.

In summary, the present invention is concerned with methods for receiving a real-time discount with an open loop debit card, credit card or mobile payment device in a multi-merchant, multi-payer commercial environment. Steps of an exemplary embodiment include maintaining a discounting system with a plurality of buckets, each bucket providing information concerning discounts currently available to each payer from each merchant, initiating a transaction between a payer and a specific merchant at a point of sale (POS) device, transmitting a query from a financial processor to an account issuing bank to determine whether the payer has sufficient funds for the transaction, communicating between the issuing bank and the discount system in real time to determine if a discount is available, if a discount is available, borrowing the amount of the discount by the issuing bank from an issuing bank discount reserve pooled (IBDRP) account and crediting the payer's account at the issuing bank in real time with the amount of the discount, and if sufficient funds are now available in the payer's account including the amount of the credited discount, responding by the issuing bank to the financial processor with approval for the transaction.

Further steps of an exemplary method include sending a settlement notification from the POS device to the financial processor, breaking down the transaction into a discount amount and a discounted gross amount, authorizing the discounted amount from the IBDRP account, authorizing the discounted gross amount from the payer's account at the issuing bank, settling the discount amount from the IBDRP account to the merchant's account, settling the remainder of the transaction from the payer's issuing bank account to the merchant's account, and reversing the discount amount offset by the IBDRP account from the merchant's account back to the discounting system.

The present invention further encompasses systems for receiving a real-time discount with an open loop debit card, credit card or mobile payment device in a multi-merchant, multi-payer commercial environment. An exemplary system may include a discounting system with a plurality of buckets, each bucket providing information concerning discounts currently available to each payer from each merchant, a point of sale (POS) device initiates a transaction between a payer and a specific merchant, a financial processor which transmits a query to an account issuing bank to determine whether the payer has sufficient funds for the transaction, the issuing bank communicates with the discount system in real time to determine if a discount is available, if a discount is available, the issuing bank borrows the amount of the discount by from an issuing bank discount reserve pooled (IBDRP) account and the issuing bank credits the payer's account in real time with the amount of the discount, and if sufficient funds are now available in the payer's account including the amount of the credited discount, the issuing bank responds to the financial processor with approval for the transaction.

In an exemplary system, the POS device sends a settlement notification to the financial processor, the financial processor breaks down the transaction into a discount amount and a discounted gross amount, the financial processor authorizes the discounted amount from the IBDRP account, the financial processor authorizes the discounted gross amount from the payer's account at the issuing bank, the financial processor settles the discount amount from the IBDRP account to the merchant's account, the financial processor settles the remainder of the transaction from the payer's issuing bank account to the merchant's account, and the financial processor reverses the discount amount offset by the IBDRP account from the merchant's account back to the discounting system.

In either the systems or the methods of the present invention, the payer's account at the issuing bank may be identified at the POS device by a credit card, a debit card, or a mobile device. The mobile device may utilize a quick response (QR) protocol, a near field communications (NFC) protocol, or a radio frequency ID (RFID) protocol.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1A is a perspective view of a basic Point of Sale (POS) device for swiping a payer's credit or debit card;

FIG. 1B is a perspective view of a more sophisticated and feature-rich retail Point of Sale (POS) device than the POS device illustrated in FIG. 1;

FIG. 2 is partially a plan view and partially a perspective view of exemplary ways to make a payment via a mobile device;

FIG. 3 is a block diagram illustrating typical steps used to process a debit card or a credit card transaction;

FIGS. 4A-4D collectively form a block diagram which illustrates the flow of typical steps encountered while processing a standard debit card, credit card or mobile payment device transaction;

FIG. 5 is a block diagram illustrating exemplary steps used to process a debit card, credit card or mobile payment device transaction with the multi-merchant real-time discounting systems and methods of the present invention;

FIG. 6 is a process flow diagram illustrating how merchants place offers, how a payer finds the offers, and how acceptance of an offer results in a financial transaction between the payer's bank and the merchant's bank;

FIG. 7 is a diagram illustrating multiple merchants, each merchant making multiple offers to eligible payers, and each merchant provided with multiple value buckets for conducting real-time discount transactions in accordance with the present invention;

FIG. 8 illustrates a flow chart for a multi-bucket account for a multi-merchant point tracking and discounting (MMPTD) for conducting real-time discount transactions in accordance with the present invention;

FIG. 9 illustrates a flow chart for an issuing bank discount reserve pooled account (IBDRPA) for conducting real-time discount transactions in accordance with the present invention;

FIG. 10 illustrates a flow chart for a real-time discounting process for conducting real-time discount transactions in accordance with the present invention; and

FIGS. 11A-11D collectively form a block diagram which illustrates the flow of typical steps encountered while processing real-time discount debit card, credit card or mobile payment device transactions in accordance with the present invention.

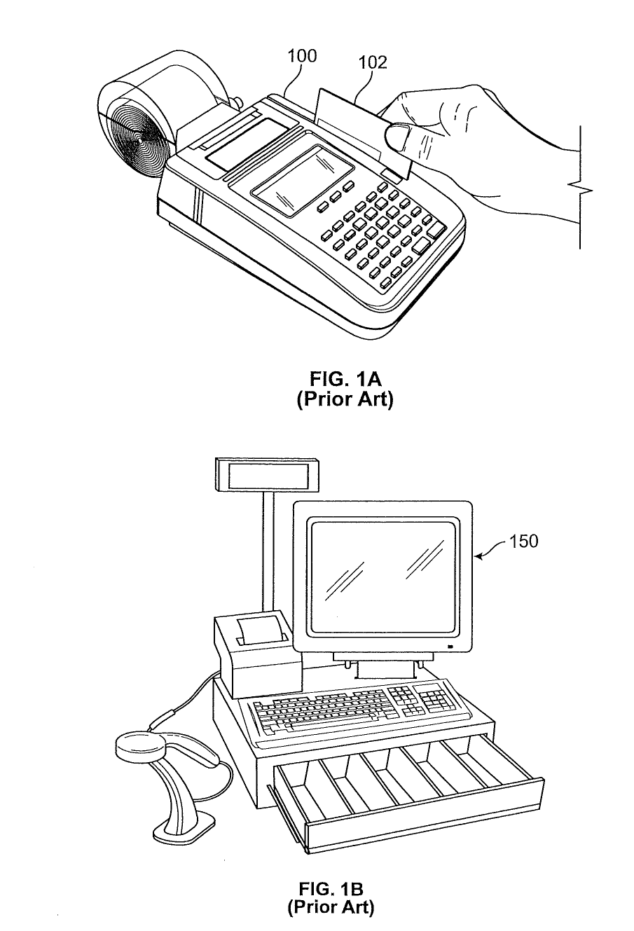

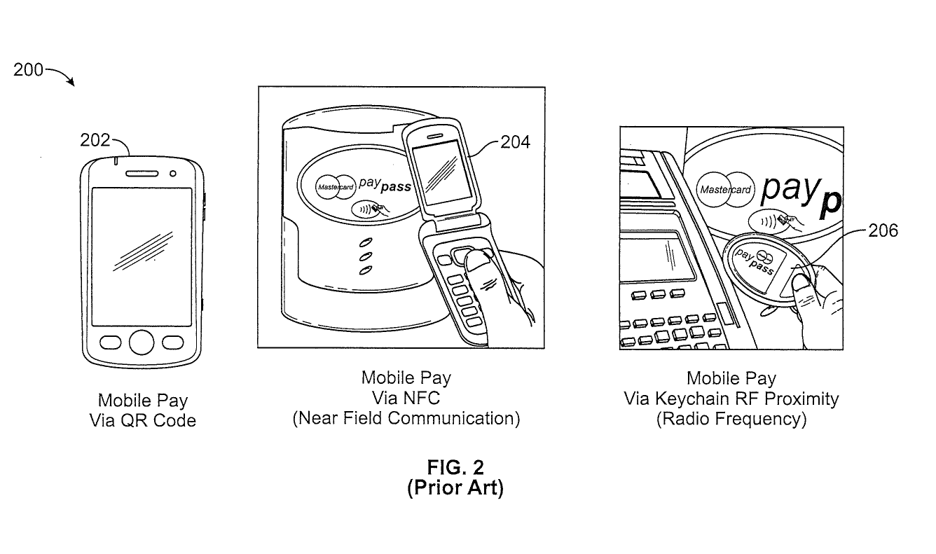

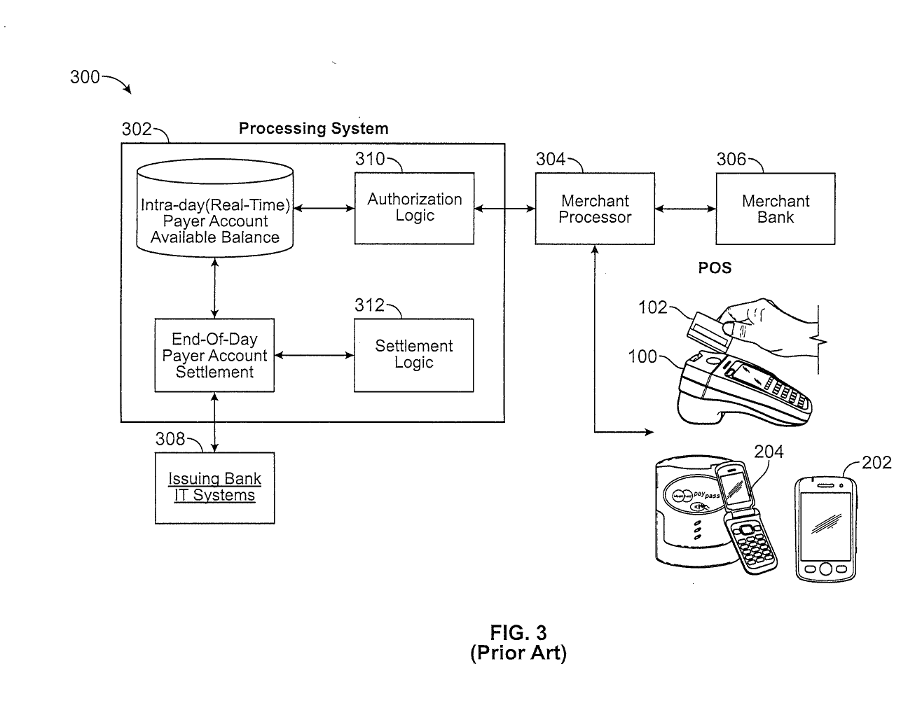

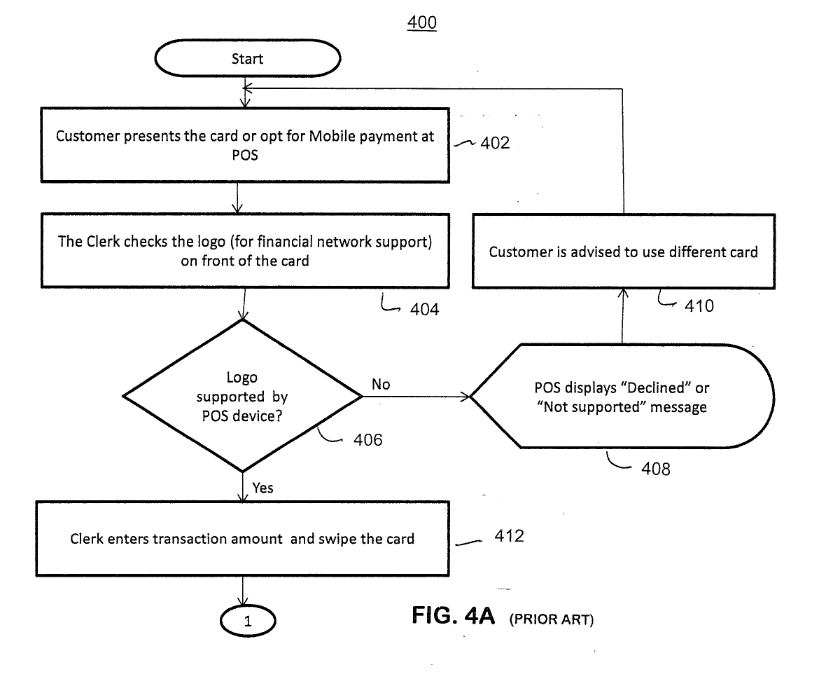

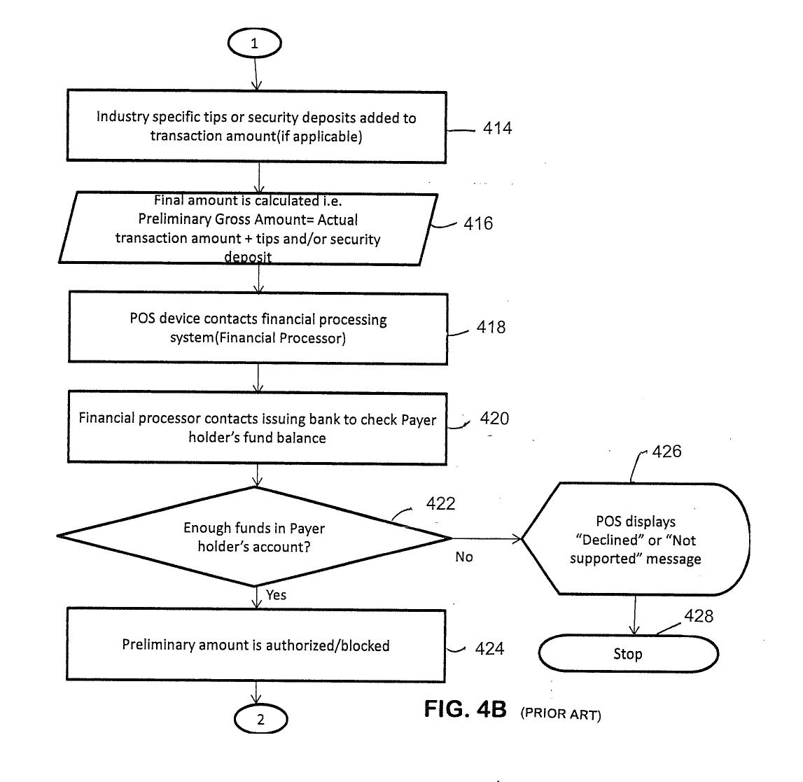

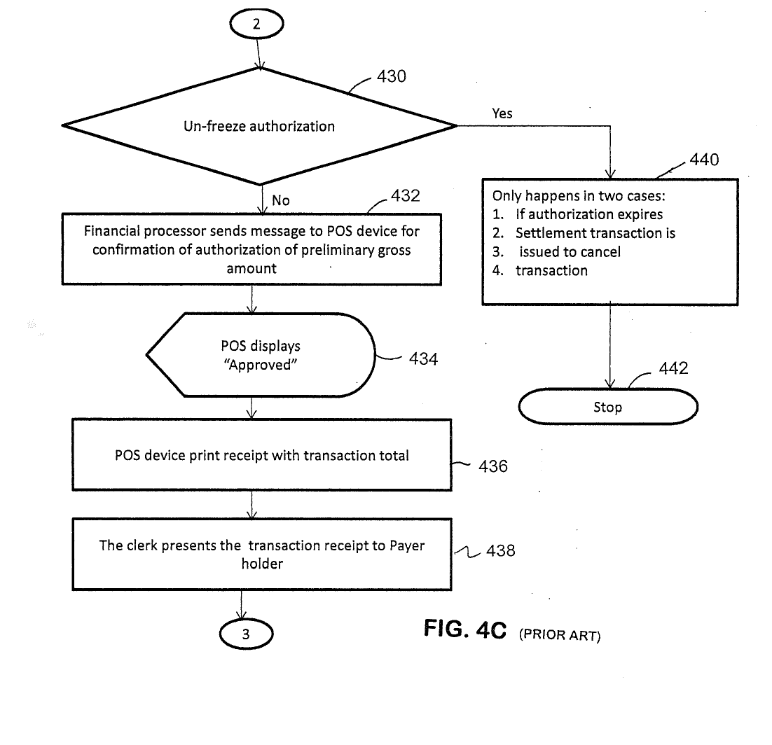

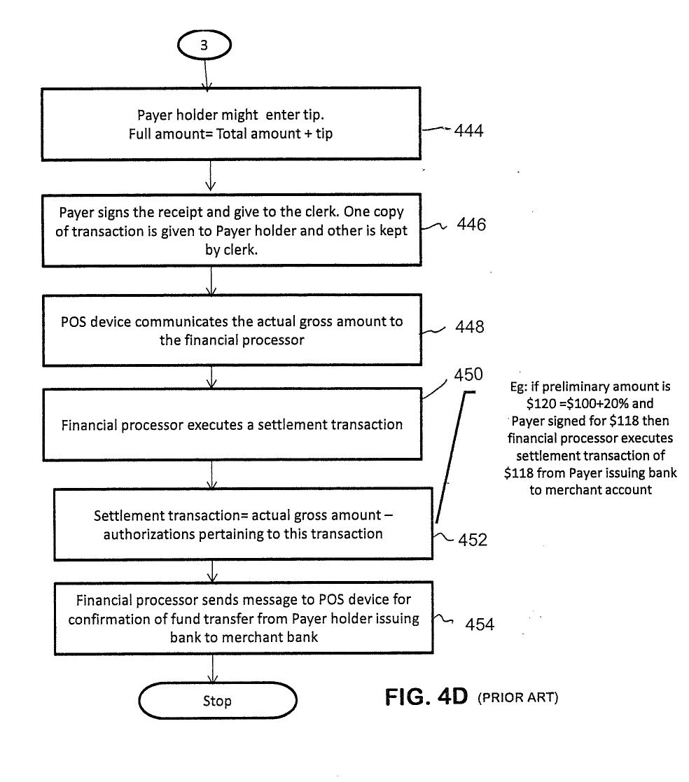

### DESCRIPTION OF THE PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

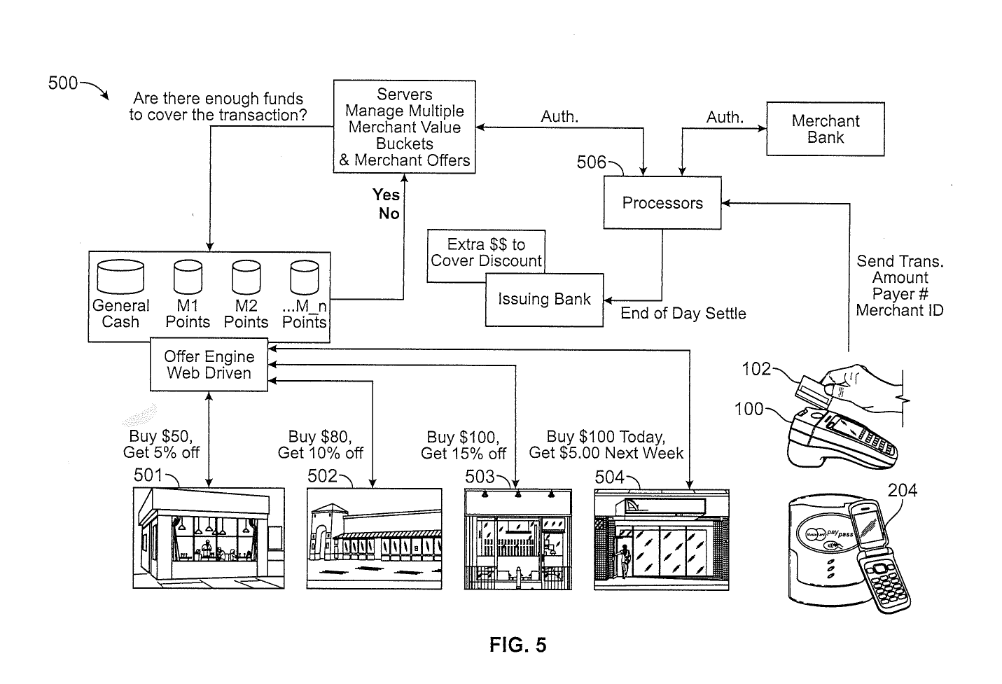

In accordance with an aspect of the present invention, FIG. 5 illustrates the operation of a commercially viable real-time electronic open loop debit card, credit card or mobile payment device discounting system 500 in accordance with the present invention. One objective of these systems and methods is to offer an electronic discounting process without breaking or altering any authorization and settlement transaction bank rules, while operating the real-time discounting system with any off-the shelf POS system 100, such as used by various brick-and-mortar or Internet merchants 501-504.

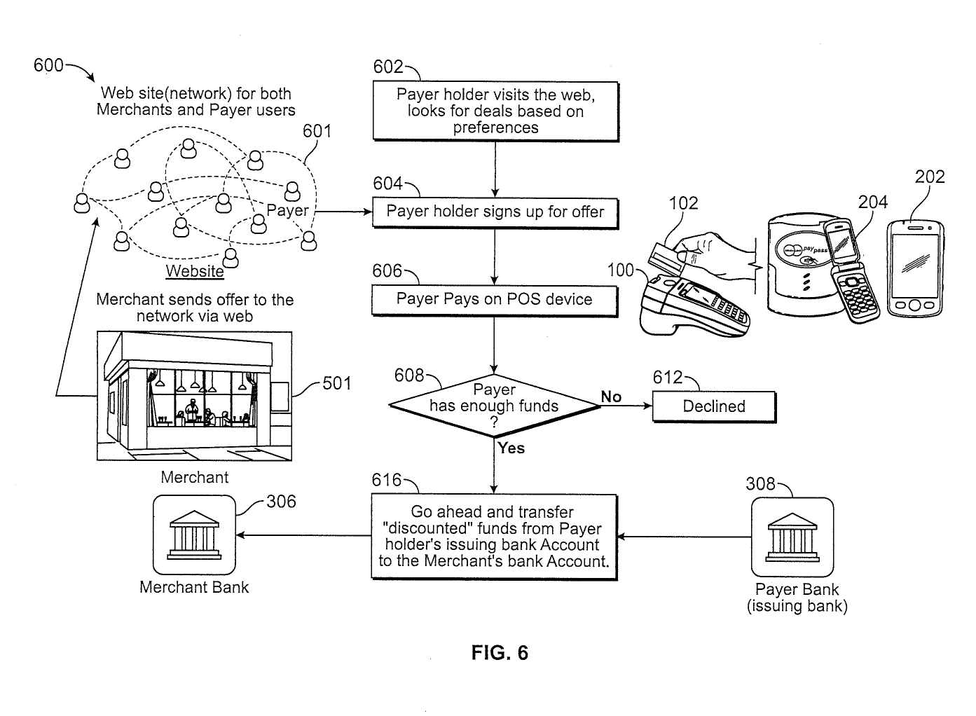

As further shown in FIG. 6, a system is an interconnected multi-payer 601, multi-merchant business oriented social network 600 which connects consumers 601 using debit cards, credit cards or mobile payment devices 102 with local businesses 501 that have a web portal and a Point of Sale (POS) device 102. The system helps buyers save money, it boosts merchant sales and it promotes buying from local small businesses.

Consumers (payers) like the system because they get various real-time electronic discount options by using their credit cards, debit cards or mobile payment devices:
1. Instant electronic discounts
2. Loyalty based electronic discounts,
3. Pre-paid electronic discounts.
4. Avoid embarrassing moments handing paper coupons in front of guests and merchant workers. All that the payers need to do is use their debit cards, credit cards or mobile payment device and immediately receive their discount.

Merchants like the system because they get the following benefits:
1. More client traffic, thus more sales and more potential to up-sell clients.
2. Ability to instantly connect with clients and notify them about special deals and discounts
3. No need to train the merchant's employees on how to discount transactions using paper coupons at the POS device, all discounts are automated and streamlined. Furthermore, there is less opportunity for merchant employee fraud, such as via collusion with consumers.
4. Ability to build loyalty with clients and to give payers incentives to come back and shop regularly.

The operation of the real-time electronic open loop debit card, credit card or mobile payment device discounting systems and methods of the present invention is as follows.

An individual visits a web portal 602 or otherwise learns about the real-time electronic open loop debit card, credit card or mobile payment device discounting, reads about the ability to get instant real-time discounts and decides to participate. He/she then applies to receive a debit card, credit card or enlists their mobile payment device by filling information required to issue a debit card, credit card or register their mobile payment device. He/she must enter personal information such as her name, date of birth, social security number, mobile phone number and any other required information. Once all information is entered correctly and is validated, the system notifies the user that the application process is complete and that the credit card or debit card is scheduled to be shipped to the user, and should be delivered within a few days; or that their mobile device is now registered with the system to received discounts.

The consumer is then issued a universally accepted debit card, credit card supported by an universally accepted international open loop payment network such as VISA™, MasterCard™, American Express™. In the case the user wants to pay with a mobile payment device, their mobile payment devices is then registered and is tied to a bank account, or a universally accepted debit card or credit card and could be presented at merchants that accept mobile payment devices.

The user then chooses a login and password to the discounting web portal. The payer then activate her account and loads it with funds from a bank account, a credit card, from various electronic funding sources or simply cash from a financial services location which loads cash to a debit card, credit card or mobile device.

Optionally, a user may log onto a social networking website, such as FaceBook (www.facebook.com) and utilize an application (app) to have access to discount offers from merchants. For example, a user may create a wish for a particular discount which may be circulated to friends. Merchants on the website may see the wish and decide whether to accept or to refuse the wish. If accepted, the wish may become a discount available to the user.

The consumer (payer) can now log into the web system and look for merchant sponsored discount offers. For example, an offer could be an instant discount offer such as: “Buy $100.00 worth of goods and get an instant $15.00 discount”; or a loyalty offer such as: “Shop at our store and accrue $200.00 over a month, then come back and get a $30.00 discount on your first transaction after your accrue the $200.00”.

Meanwhile, merchants are recruited to go online and sign up for the discounting web portal system, and are added to the list of merchants offering discounts. The merchant uploads information about its business, so they can create offers which can be broadcasted or otherwise issued to the payers. An offer could be an instant discount offer such as: “Buy $100.00 worth of goods and get an instant $15.00 discount”; or a loyalty offer such as: “Shop at our store and accrue $200.00 over a month, then come back and get a $30.00 discount on your first transaction after your accrue the $200.00”.

Once the merchant completes their application and publishes the discount offer, payers can now go online and register for the published offers, then go to the merchant's locations or web portal and get the promised discounts (step 604).

The discounting web portal system notifies users of special deals offered by various merchants based on user preferences, home address zip code and other location/geo-location details, interests and personal settings. The merchant configures the offer so that interested consumers either pre-pay for the offer or pay down a certain down payment. The down payment amount could also be zero if the merchant prefers not to ask for upfront commitment from the consumer. Signing up for a discount without paying any upfront fees or deposits is like picking up a coupon discount from a free newspaper. The only difference here is that: once the user signs up for the coupon discount and it is added to his profile, then they don't need to show up at the merchant's location with a paper coupon, the discount is automatically calculated, subtracted and settled without any effort.

Merchants create and upload various discount offers to the discounting web portal. Discount offers may vary from one merchant to another. However the offers are preferably classified into three main categories:
1. Instant offer: Buy a minimum of X dollars-worth of spending, receive Y dollars (or %) in discounts. This offer enables the payer to get instant discounts on their purchase. For example, the offer could be: spend $100 today at the merchant and get $20 off. With the instant discount, the shopper does not have to accumulate a certain number of buying power, then come back to get the discount (Loyalty model) nor do they have to put up any upfront cash to pre-purchase any spending.
2. Loyalty: If you Purchase X dollars today, then you get Y free spending dollars next time. For example, if you spend $100 today, then you get a $20 discount in your next purchase. This “next purchase” could be (a) with no time limits, or (b) time limited. In other words, if you spend $100 today, then you (a) get a $20 discount at any of your next purchases which could be 5 minutes right after the first purchase; or (2) the $20 discount is only in effect if your next purchase takes place after three days from the first purchase and expires by end of the month.
3. Prepaid: Pre-purchase X dollars-worth of spending for Y dollars (where Y is less than X). For example, pre-purchase $100 worth of spending for $80. Payers go online and pre-purchase a certain amount of spending dollars (value) at a discount; then they go to the merchant's location (or online) and shop.

Based on the three categories described above, the following offer sub-categories are provided:
a. Instant real-time (%) percentage electronic discount: Within a given time period, if you buy more than X with your debit card, credit card or mobile payment device, then you get an immediate Y% discount. For example, the offer could be: If you use your card to buy more than $100.00 between May 1^{st} and May 15^{th}, then you get an immediate real-time 10% off your transaction.
b. Instant real-time fixed amount electronic discount: Within a given time period, if you buy more than X with your debit card, credit card or mobile payment device, then you get an immediate fixed Y discount. For example, the offer could be: If you use your card to buy more than $100.00 between May 1^{st} and May 15^{th}, then you get an immediate real-time fixed discount of $10 off your transaction.
c. Pre-pay electronic discount: Within a given time period, if you pre-pay X using your debit card, credit card or mobile payment device, then you get to spend Y amount at our location or web portal. For example, the offer could be: If you use your credit card, debit card or mobile payment device and pre-pay $80.00 between May 1^{st} and May 15^{th}, then you get to buy goods and services (using your debit card, credit card or mobile payment device) worth $100 at our location or web portal.
d. Accumulated purchase electronic discount: Within a given time period, if you accumulate purchases which exceed X using your debit card, credit card or mobile payment device, then you get to spend Y amount at our location or web portal. buy more than X with your debit card, credit card or mobile payment device, then you get an immediate fixed Y discount. For example, the offer could be: If you use your card to buy more than $100.00 between May 1^{st} and May 15^{th}, then you get an immediate real-time fixed discount of $10 off your transaction.
e. “Next-Time” Instant fixed discount based on prior purchase activities: Within a given time period, if you accumulate purchases which exceed X using your debit card, credit card or mobile payment device, then from date d1 to d2, you get to an instant electronic Y discount at our location or web portal. For example, the offer could be: If you use your card to buy more than $100.00 between May 1^{st} and May 15^{th}, then from June 1^{st} to June 15^{th}, you get an instant real-time fixed discount of $10 off your transaction.
f. “Next-Time” Instant percentage (%) discount based on prior purchase activities: Within a given time period, if you accumulate purchases which exceed X using your debit card, credit card or mobile payment device, then from date d1 to d2, you get to a percent (%) electronic Y discount at our location or web portal. For example, the offer could be: If you use your card to buy more than $100.00 between May 1^{st} and May 15^{th}, then from June 1^{st} to June 15^{th}, you get a 10% real-time off your transaction.
g. Stepwise variable (%) percentage discount based on the number of signed up payers: Within a given time period, if between n to m number of payers are subscribed (signed up) to this offer, and you buy more than X with your debit card, credit card or mobile payment device, then you get an immediate Y% discount; Note that this Y% discount will vary on the number of signed up consumers; for example:
   1. 10% discount, 0-100 users are signed up: If you use your card to buy more than $100.00 between May 1^{st} and May 15^{th}, and 0-100 users are signed up for this offer, then you get an immediate real-time 10% off your transaction.
   2. 20% discount, 100-200 users are signed up: If you use your card to buy more than $100.00 between May 1^{st} and May 15^{th}, and 100-200 users are signed up for this offer, then you get an immediate real-time 20% off your transaction.
   3. 30% discount, 200-300 users are signed up: If you use your card to buy more than $100.00 between May 1^{st} and May 15^{th}, and 200-300 users are signed up for this offer, then you get an immediate real-time 30% off your transaction.

Consumers may then sign up for one or more of the merchant offers (step 604). After receiving the notification from the merchant and based on his/her preference, if interested, the consumer (payer) registers for the offer, and is requested to: (1) Pre-pay for the offer, (2) Pay down a portion of the offer, or (3) simply not pay any money, if the merchant decides not to require any commitment from the consumer.

If payment is required to sign up for the offer, the consumers or payers then pay at the POS or on the web and receive their real-time discounts (step 606). The system is then ready to automatically discount the transaction in real-time at the Point of Sale without authorizing the full amount from the payer.

In accordance with an aspect of the present invention, the systems and methods automatically and in real-time discount the payer's transaction as follows:
1. The payer visits the merchant's physical location or web portal, and transacts using her debit card, credit card or mobile payment device.
2. The consumer uses her debit card, credit card or mobile payment device to pay at the merchant's location, or the user checks out his/her shopping cart using his/her credit card, debit card or mobile payment device.
3. The payment processing system intercepts the card-holder's transaction, identifies that the payer is registered for discounts with the merchant.
4. If the transaction meets the offer specifics mentioned in the prior paragraph, then the payment processing and discounting system takes the following three steps:
   a. It calculates the non-discounted amount, the net discounted amount, and the size of the discount.
   b. The system withdraws only the net discounted amount from the payer's issuing bank account (step 610).
   c. The system then borrows the discount amount from a pool of funds owned by an external entity (not the payer) which is dedicated to restore discounted settlement transactions to their original transaction amount. This is done so that the settlement transaction could successfully go through a universal open loop payment networks.
   d. The system then sends the undiscounted settlement amount (discounted settlement from the payer's account+borrowed discount=original settlement amount). Thus guaranteeing that the settlement amount sent to the merchant account is equal to the settlement amount requested by the POS device or web shopping cart.
5. Once the settlement transaction is successfully processed and settlement funds are deposited into the merchants bank account (where the settled funds are equal to=discounted amount from the payer's bank account+borrowed discount); The system then issues a reverse settlement transaction where the issuing bank is the party requesting the borrowed discount to be settled back into the borrowing pool account. This transaction reversal is of course explained to the merchant and is legally authorized by the merchant upon joining the discounting web portal system. Thus it will not be a surprise for the merchant to see a set of payer to merchant settlement transactions followed by merchant to issuing bank reverse settlement transactions to put back the borrowed discounts.
6. Note that, if the payer is signed up for the discount offer, then instead of charging the user the full amount then refunding the discount portion at a later time; this system will only debit the payer's account the net discounted amount and top off the remainder (the discount) from a borrowing pool.

The attractiveness of the present invention to the payer is that it allows the payer to never be charged the full settlement amount and be able to only pay the discounted amount, which is great when the payer does not have enough funds to cover the full undiscounted amount. For example, if a payer signs up for a 30% instant discount and eats at a restaurant for $100 worth, but only has $70 in their issuing bank account. Then, this system will initially settles $100 with the merchant even though the payer only has $70 in their bank account. If we were to request the payer to settle the full amount first, then refunded them the discount later; then the payer's transaction will be declined. Mainly because the transaction is $100 and the payer only has $70 available in their account. We believe that the “pay in full and get a refund later” approach, although is used by many, is inconvenient, could cause embarrassment and could lead to unnecessary quarrel between the payer and the merchant, even though both parties know that the buyer has signed up for a 30% discount, has consumed $100 worth and is only liable for $70.

The real-time discounting aspects of this invention make it a very convenient solution to both merchants and consumers.

The consumers are happy because they can now use the real-time discounting system, sign up for merchant discounts and get only charged for the discounted net amount only. Meanwhile, merchants are happy because they increase sales and customer loyalty.

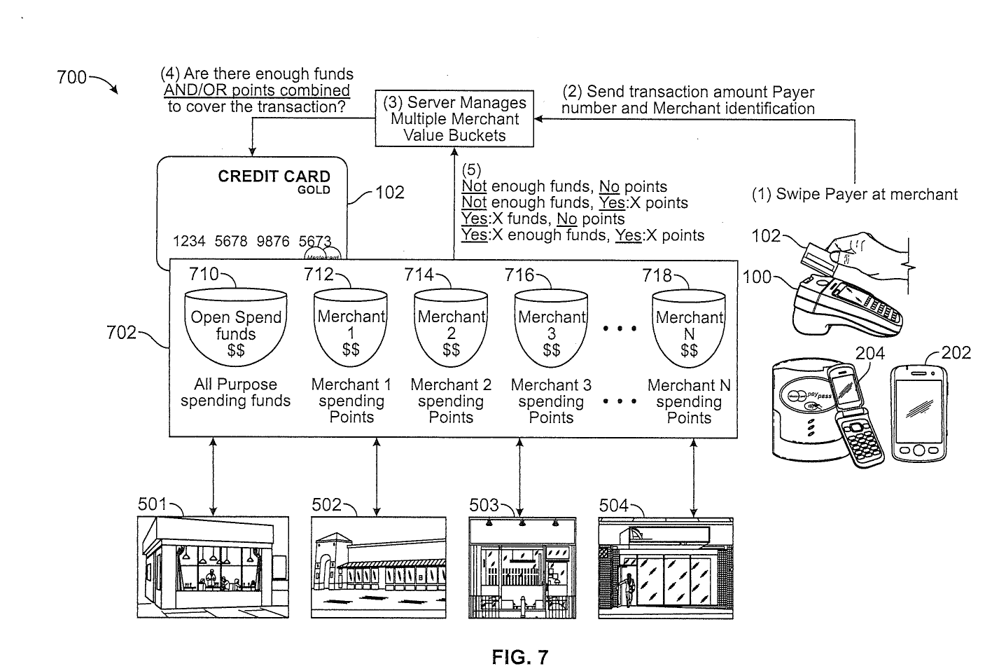

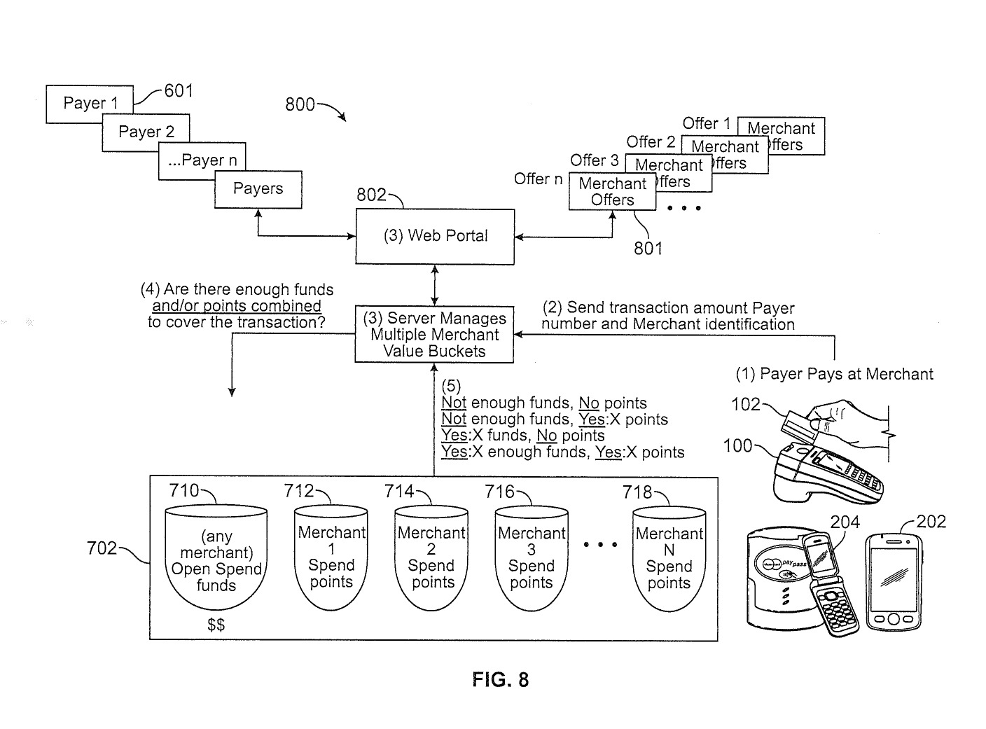

In accordance with another aspect of the present invention and as shown in FIGS. 7 and 8, the systems and methods utilize a multi-bucket payer account 702 with Multi-Merchant Point Tracking and Discounting (MMPTD) system 800. The Multi-Merchant Point Tracking and Discounting system is an automated transaction processing system which tracks payer transactions across millions of merchants 501-504. The system 800 tracks each payer's account and allocates “multiple buckets”, where each bucket corresponds to a merchant purchase activity.

Each bucket 702 contains discount points which the payer has earned. Furthermore, the MMPTD system tracks each offer 801 which the payer 601 has signed up for, and tracks prior/current purchase activities to calculate the corresponding discount points per each bucket..

If the payer 601 is registered for a specific discount offer, then when transacting at the merchant's POS 100, the MMPTD system 800 will also automatically look at available points corresponding to the merchant's “bucket” 702 and makes a Yes/No decision to discount the transaction in real-time. If the payer has not signed up for any of the merchant's discounts, then the system would charge the transaction from the “all-purpose” cash bucket and the payer will pay the full amount.

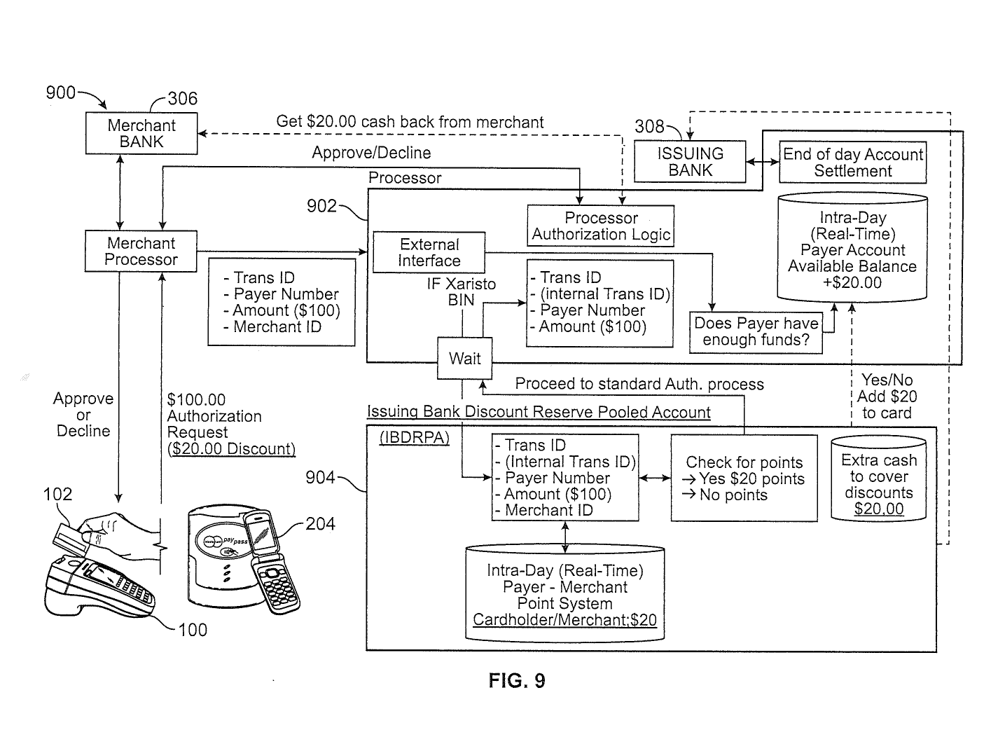

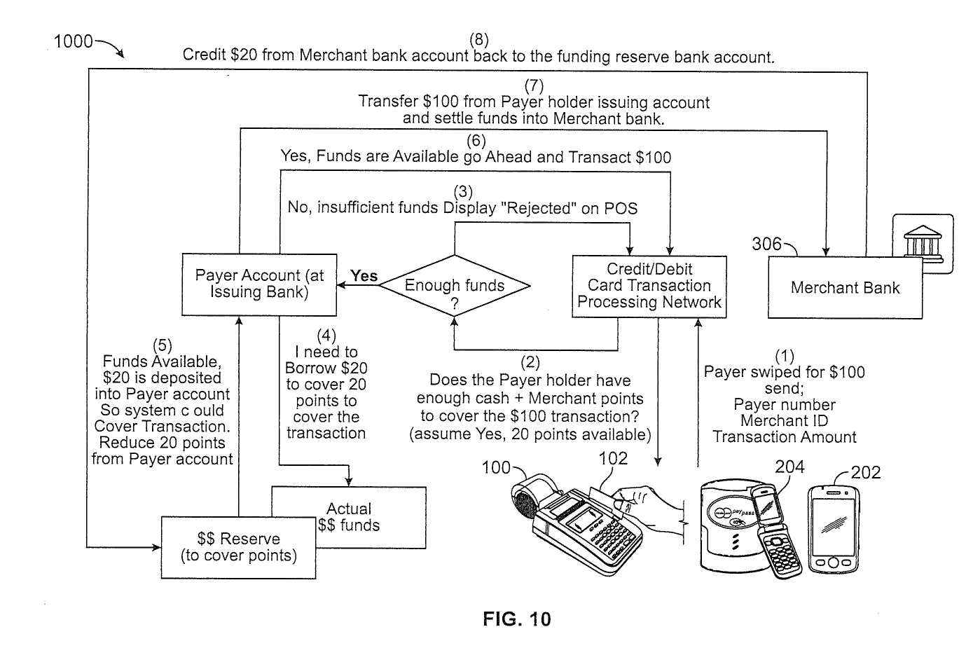

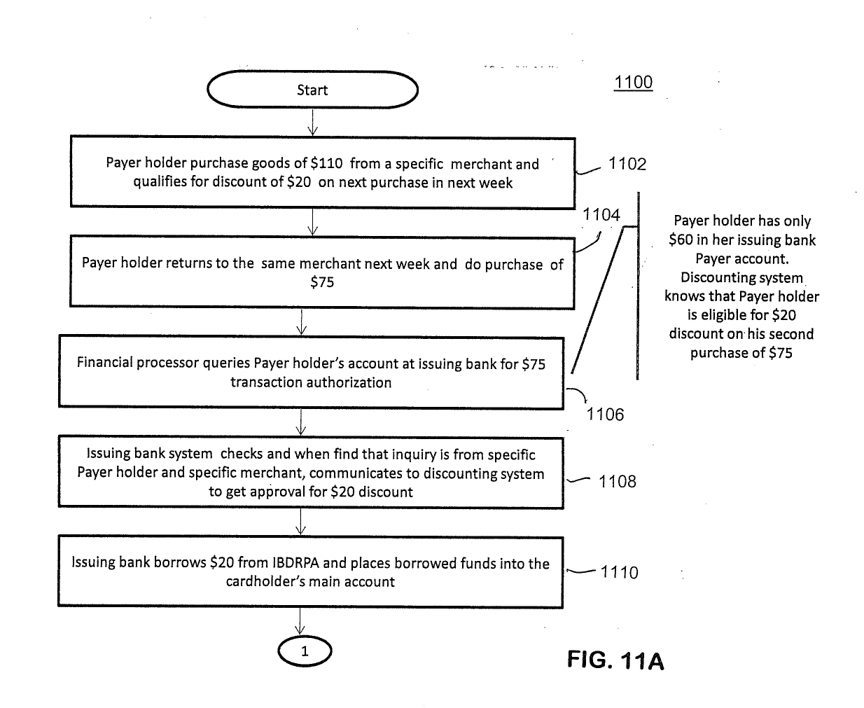

In accordance with a further aspect of the present invention and as shown in FIG. 9, the systems and methods utilize an Issuing Bank Discount Reserve Pooled Account (IBDRPA) 900. IBDRPA is a borrowing account which resides on the issuing bank 308 side which will be used to borrow funds to offset the discounts which the payer expects to receive in a transaction, but is not willing to pay for upfront. Funds must be borrowed, and the full settlement amount must be restored in order to be able to pass the settlement transaction via a universal open loop payment network. Otherwise the universal open loop payment network would flag the inconsistency of the issuing bank's settlement transaction as being less than the expected settlement transaction by the merchant's bank, thus failing to move funds from the payer to the merchant.

To better understand the value of the IBDRPA, let's look at this more detailed sample scenario: consider a discount loyalty offer where a merchant presents clients with the following offer: “Get $20 off your next purchase if you buy $100.00 worth of goods from us this week”.
1. Let's assume that a payer has already purchased $110.00 worth of goods this week, and he/she qualifies for the discount offer upon his/her return to the store next week.
2. Upon returning to the store, the payer decides to buy a $75.00 item. However, he/she only has $60.00 in funds in his/her issuing bank card account! If the system were to authorize the full $75.00 transaction amount from the payer's account, then offer him/her the $20.00 discount post transaction (not in real-time); then the POS device will decline the transaction and our payer will have to go home empty-handed because he/she only has a $60.00 balance.
4. However, if we were to involve a short term funding source which loans the payer his/her earned $20.00 discount, and if we were to combine the $20.00 loan with the payer's $60.00 balance, thus generating an $80 total balance ($80=$20+$60); then the $75.00 transaction will be approved by the financial processor and the payer will be happy.
5. The $20.00 funding source suggested will come from the Issuing Bank Discount Reserve Pooled Account (IBDRPA).

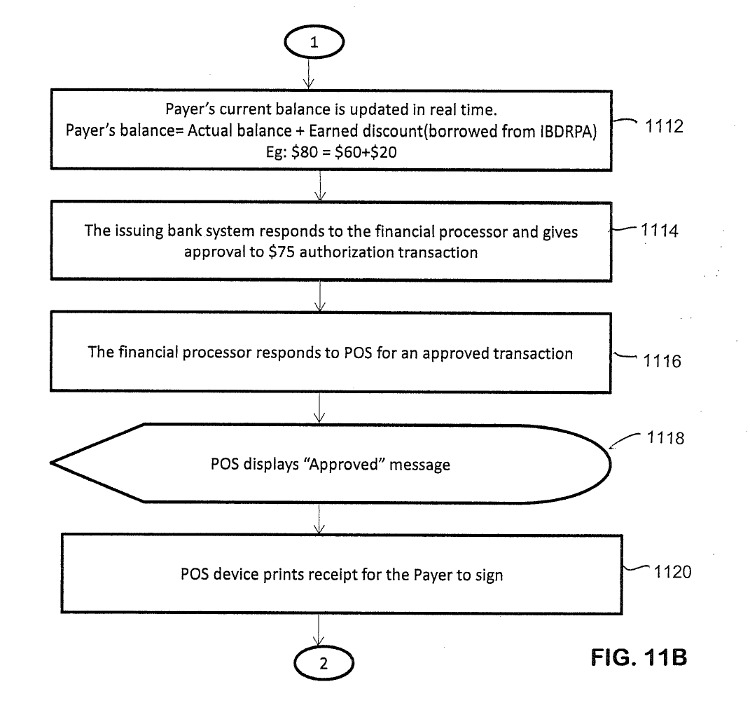

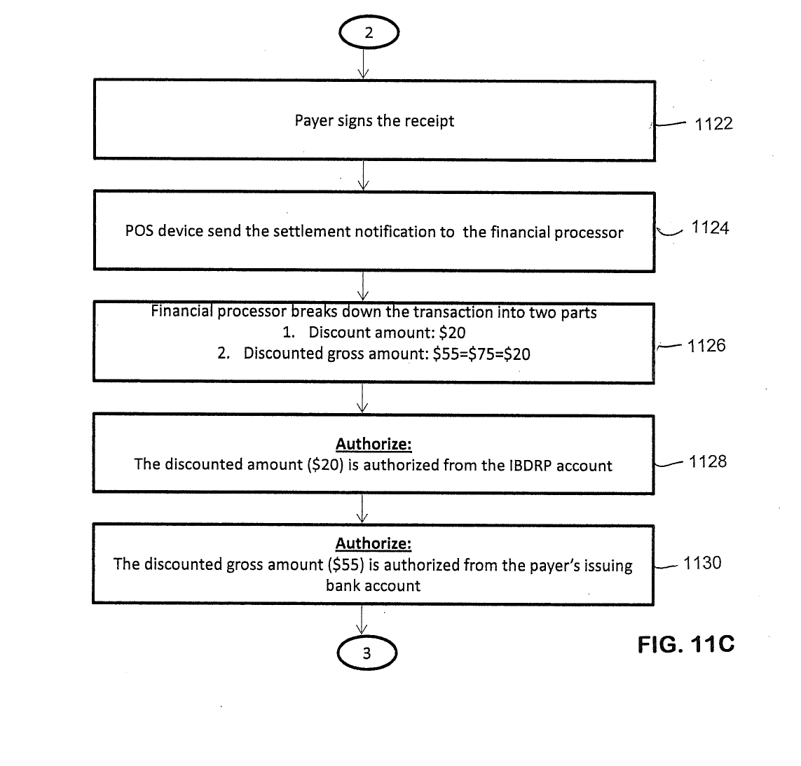

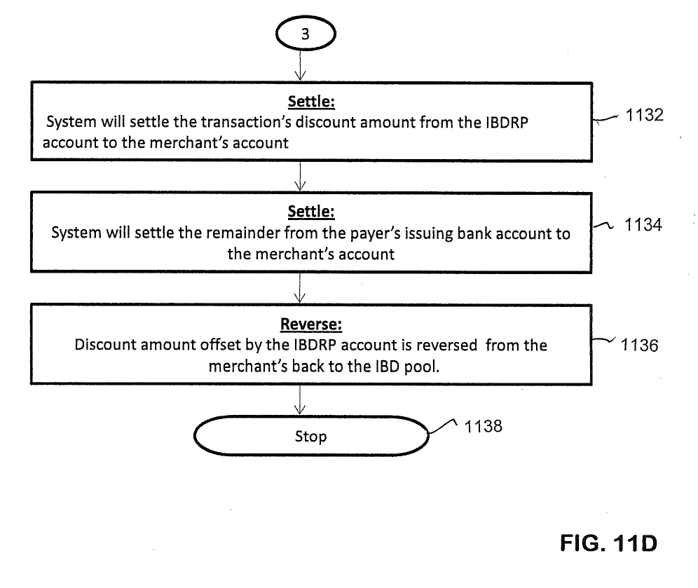

Real-Time Discounted Transaction flow using IBDRPA, As discussed earlier, our objective is to have the POS device display “Approved” on a $75.00 transaction in real-time while the payer only has $60.00 in his/her issuing bank card balance. To achieve this, here are the steps taken as shown in FIGS. 11A-11D:
1. Based on the discounting system (discussed above), we know that the user is due for a $20.00 discount (step 1102) on his/her next purchase at the specific merchant.
2. The financial processor 902 then queries to determine if the payer's account can accommodate a $75.00 transaction authorization (steps 1104 and 1106).
3. Upon receiving an inquiry from the financial processor, where the inquiry involves the specific merchant and the specific payer, the issuing bank system 308 communicates to the discounting system 904 and gets approval that the payer has earned a $20.00 discount (step 1108).
4. The issuing bank system 308 then borrows in real-time $20.00 from the IBDRPA 904, and places the borrowed funds into the payer's main account (step 1110).
5. The payer's current balance is updated in real-time, is now $80.00=$60.00 (actual balance)+$20.00 (earned discount, borrowed from the IBDRPA) (step 1112).
6. The issuing bank system 308 responds to the financial processor 902 and gives approval to the $75.00 authorization transaction (step 1114).
7. The financial processor 902 responds to the POS 100 with an approved message (step 1116). The POS displays “Approved” (step 1118) and prints a receipt for the payer to sign (step 1120). For simplicity sake, let's assume that there are no tips or additions to the $75.00 transaction.
8. The payer signs the receipt (step 1122), and leaves the merchant's location. The POS device sends a Settlement notification (step 1124).
9. Immediately after sending the approval, financial processing system breaks down the transaction into two parts: (1) the discounted amount: $20.00, and (2) the discounted gross amount: $55.00=$75.00−$20.00 (step 1126). These two values need to be known so that the amount of funds needed to settle out the payer's account is available.
10. Authorize: (i) The discounted amount is authorized (reserved and frozen) from the IBDRPA account (step 1128). (ii) The discounted gross amount is authorized (reserved and frozen) from the payer's issuing bank account (step 1130).
11. Settle: After the payer signs for the transaction, the system 900 will settle funds as follows: (i) From the IBDRPA account: Settle the transaction's discount amount from the IBDRPA account to the merchant's account (step 1132). (ii) From the payer's issuing bank account: Settle the remainder from the payer's issuing bank account to the merchant's account (step 1134).
12. Reverse: The discount amount offset by the IBDRPA account is then reversed from the merchant's account back to the IBD pool (step 1136), so that the funds could be used again to offset the discount of another transaction. The reverse transaction is actually a combined: Authorize and settle for the discount amount, except in this case the payer is the merchant and the acquirer is the IBDRPA account. Thus the reversal/refund of the borrowed discount amount from the merchant back to the IBDRPA.

In summary, the payer is given a seamless experience where the payer only pays for the discounted transaction; funds are withdrawn from the IBDRPA account; and the IBDRPA funds are used to offset the settlement of the discount portion. Then these funds are refunded back to the issuing bank.

As a result, for every open loop debit card, credit card or mobile payment device 102 issued to a payer, a small separate IBDRPA account is created. Then, all separate discount reserve accounts are pooled in order to build a scalable multi-million user card system. This approach provides a discounting process which is seamless, automated and executed in real-time.

Payers using these real-time discounting systems and methods do not have to carry multiple gift cards, cut coupons or carry multiple loyalty cards on their key chains. All the payers need to do is to apply for a debit card, credit card or register their mobile payment device, and after being authenticated and successfully added to the system, they just log onto the discounting web portal, sign up for various merchant discounts, then visit the merchant's location or merchant's ecommerce web site, seamlessly transact the desired offers and discounts are automatically processed in real time in a hassle free manner.

While particular embodiments of the invention have been shown and described, it will be obvious to those skilled in the art that changes and modifications may be made therein without departing from the invention in its broader aspects.

1. A method for receiving a real-time discount with an open loop debit card, credit card or mobile payment device in a multi-merchant, multi-payer commercial environment, said method comprising the steps of:
maintaining a discounting system with a plurality of buckets, each bucket providing information concerning discounts currently available to each payer from each merchant;
initiating a transaction between a payer and a specific merchant at a point of sale (POS) device;
transmitting a query from a financial processor to an account issuing bank to determine whether the payer has sufficient funds for the transaction;
communicating between the issuing bank and the discount system in real time to determine if a discount is available;
if a discount is available, borrowing the amount of the discount by the issuing bank from an issuing bank discount reserve pooled (IBDRP) account and crediting the payer's account at the issuing bank in real time with the amount of the discount; and
if sufficient funds are now available in the payer's account including the amount of the credited discount, responding by the issuing bank to the financial processor with approval for the transaction.

2. The method of claim 1 wherein the payer's account at the issuing bank is identified at the POS device by a credit card, a debit card, or a mobile device.

3. The method of claim 2 wherein the mobile device utilizes a quick response (QR) protocol, a near field communications (NFC) protocol, or a radio frequency ID (RFID) protocol.

4. The method of claim 1 comprising the further steps of:
sending a settlement notification from the POS device to the financial processor;
breaking down the transaction into a discount amount and a discounted gross amount;
authorizing the discounted amount from the IBDRP account;
authorizing the discounted gross amount from the payer's account at the issuing bank;
settling the discount amount from the IBDRP account to the merchant's account; and
settling the remainder of the transaction from the payer's issuing bank account to the merchant's account.

5. The method of claim 1 comprising the further step of:
reversing the discount amount offset by the IBDRP account from the merchant's account back to the discounting system.

6. A system for receiving a real-time discount with an open loop debit card, credit card or mobile payment device in a multi-merchant, multi-payer commercial environment, said system comprising:
a discounting system with a plurality of buckets, each bucket providing information concerning discounts currently available to each payer from each merchant;
a point of sale (POS) device initiates a transaction between a payer and a specific merchant;
a financial processor which transmits a query to an account issuing bank to determine whether the payer has sufficient funds for the transaction;
the issuing bank communicates with the discount system in real time to determine if a discount is available;
if a discount is available, the issuing bank borrows the amount of the discount by from an issuing bank discount reserve pooled (IBDRP) account and the issuing bank credits the payer's account in real time with the amount of the discount; and
if sufficient funds are now available in the payer's account including the amount of the credited discount, the issuing bank responds to the financial processor with approval for the transaction.

7. The system of claim 6 wherein the payer's account at the issuing bank is identified at the POS device by a credit card, a debit card, or a mobile device.

8. The system of claim 7 wherein the mobile device utilizes a quick response (QR) protocol, a near field communications (NFC) protocol, or a radio frequency ID (RFID) protocol.

9. The system of claim 6 further comprising:
the POS device sends a settlement notification to the financial processor;
the financial processor breaks down the transaction into a discount amount and a discounted gross amount;
the financial processor authorizes the discounted amount from the IBDRP account;
the financial processor authorizes the discounted gross amount from the payer's account at the issuing bank;
the financial processor settles the discount amount from the IBDRP account to the merchant's account; and
the financial processor settles the remainder of the transaction from the payer's issuing bank account to the merchant's account.

10. The system of claim 9 further comprising:
the financial processor reverses the discount amount offset by the IBDRP account from the merchant's account back to the discounting system.
